(19) United States
(12) Patent Application Publication
(10) Pub. No.: US 2017/0238330 A1
(43) Pub. Date: Aug. 17, 2017

(54) BASE STATION, USER EQUIPMENT AND ASSOCIATED METHODS

(71) Applicant: SHARP KABUSHIKI KAISHA, Sakai City, Osaka (JP)

(72) Inventors: Qi JIANG, Shanghai (CN); Renmao LIU, Shanghai (CN); Ming DING, Shanghai (CN)

(73) Assignee: SHARP KABUSHIKI KAISHA, Sakai City, Osaka (JP)

(21) Appl. No.: 15/501,488

(22) PCT Filed: Aug. 6, 2015
(86) PCT No.: PCT/CN2015/086238

§ 371 Date: Feb. 3, 2017

(30) Foreign Application Priority Data
Aug. 6, 2014 (CN) 201410383999.2

(51) Int. Cl. H04W 72/08; H04W 24/10; H04W 72/04; H04W 16/14

(52) U.S. Cl. CPC H04W 72/085; H04W 16/14; H04W 24/10; H04W 72/0453; H04W 72/042

(57) ABSTRACT

The present disclosure provides a method in a base station. The method comprises: transmitting to a User Equipment (UE) a measurement configuration set comprising one or more measurement configurations each for configuring measurement for one unlicensed carrier; receiving from the UE a measurement report set comprising one or more measurement reports each associated with one unlicensed carrier configured by at least one measurement configuration in the measurement configuration set; and allocating resources on one or more unlicensed carriers to the UE based on the measurement report set.

### TECHNICAL FIELD

The present disclosure relates to wireless communications, and more particularly, to a base station, a User Equipment (UE) and associated methods.

### BACKGROUND

Modern wireless mobile communication systems have two significant characteristics. The first one is broadband and high rate. For example, the fourth generation wireless mobile communication systems have up to 100 MHz of bandwidth and up to 1 Gbps of downlink rate. The second one is mobile interconnecting, which enables emerging services such as mobile Internet, mobile video on demand, online navigation, and the like. These two characteristics have higher requirements on the wireless mobile communication technology, including ultrahigh rate wireless transmission, inter-area interference suppression, reliable signal transmission while moving, distributed/centered signal processing, etc. In the enhanced fourth generation (4G) and the fifth generation (5G) in the future, in order to meet the above development requirements, various key techniques have been proposed and discussed, and are worth extensive attention of researchers in the related field.

In October of 2007, the International Telecom Union (ITU) has approved the Worldwide Interoperability for Microwave Access (VViMAX) as the fourth 3G system standard. This event, which happened at the end of the 3G era, is in fact a rehearsal of the 4G standard war. Indeed, in order to confront the challenges from the wireless IP technology represented by wireless local area network (WLAN) and WiMAX, the 3GPP organization has set out to prepare for its new system upgrade—standardization of the Long Term Evolution (LTE) system. As a quasi-4G system which is based on Orthogonal Frequency Division Multiplexing (OFDM), the LTE system had its first release published in 2009, and was subsequently put into commercial use in 2010. Meanwhile, the standardization of the 4G wireless mobile communication system was also started by 3GPP in the first half of 2008, and this system were referred to as Long Term Evolution Advanced (LTE-A). The critical standard specification for physical layer procedures of that system was completed in early 2011. In November of 2011, the ITU officially announced in Chongqing, China that the LTE-A system and the WiMAX system are two official standards for 4G systems. Nowadays, global commercialization of the LTE-A system is progressing step by step.

According to the challenges of the next decade, the enhanced fourth generation wireless mobile communication systems have generally the following development requirements:
Higher wireless broadband rate and optimization of local cell hot spots;
Further improved user experience, especially optimization of communication services for cell border areas;
Continuous researches on new techniques capable of improving spectral utilization, due to impossibility of 1,000 times of expansion of available spectrums;
Use of high frequency spectrums (5 GHz or even higher) to obtain large communication bandwidth;
Cooperation with existing networks (2G/3G/4G, WLAN, WiMax, etc.) to share data traffic;
Specific optimization for different traffics, applications and services;
Enhanced system capabilities for supporting large scale Machine Type Communications;
Flexible, intelligent and inexpensive network planning and deployment; and
Designs for saving power consumptions of networks and UE batteries.

In the conventional 3GPP LTE system, data transmission can only occur on licensed carriers, or licensed bands. However, with the rapid growth of traffic, it may be difficult for the licensed bands to satisfy the requirements of the increasing traffic, especially in some urban hot-spots. In the 3GPP RAN #62 meeting, a new research topic, i.e., a study on unlicensed carriers (or unlicensed bands), has been discussed (RP-132085). Its main purpose is to study non-standalone deployment of LTE on unlicensed carriers. The term “non-standalone” means that communication on an unlicensed carrier is associated with a serving cell on a licensed carrier. A straightforward scheme is to reuse the Carrier Aggregation (CA) feature in the LTE system, i.e., to deploy a licensed carrier as a Primary Component Carrier (PCC) of a serving base station and an unlicensed carrier as a Secondary Component Carrier (SCC) of the serving base station.

However, when the conventional LTE system is applied on an unlicensed carrier, the following problems may rise:
There could be networks with other access technologies on the unlicensed carrier, e.g., Wi-Fi network coverage. The LTE system needs to detect a channel quality of the unlicensed carrier before accessing the unlicensed carrier, so as to avoid interference with the other access networks (e.g., Wi-Fi). Currently, the LTE system cannot support such measurement operations
The bandwidth of the unlicensed carrier may be much wider than the maximum bandwidth the LTE system supports (100 MHz). The network side needs to configure UEs with the unlicensed carrier that can be inter-carrier scheduled.

There is thus a need for a new solution for measurement and/or resource allocation for an unlicensed carrier.

### SUMMARY

It is an object of the present disclosure to provide a base station, a UE and associated methods, capable of measuring and/or allocating resources for an unlicensed carrier.

According to a first aspect of the present disclosure, a method in a base station is provided. The method comprises: transmitting to a User Equipment (UE) a measurement configuration set comprising one or more measurement configurations each for configuring measurement for one unlicensed carrier; receiving from the UE a measurement report set comprising one or more measurement reports each associated with one unlicensed carrier configured by at least one measurement configuration in the measurement configuration set; and allocating resources on one or more unlicensed carriers to the UE based on the measurement report set.

In an embodiment, each measurement configuration comprises a carrier identifier for identifying the configured unlicensed carrier.

In an embodiment, each measurement configuration further comprises a Received Signal Strength Indicator (RSSI) report threshold indication for indicating an RSSI report threshold. The UE should transmit a measurement report when an RSSI measured by the UE on the unlicensed carrier is lower than the RSSI report threshold.

In an embodiment, each measurement configuration further comprises a reference signal configuration indication for indicating a time/frequency position of an unlicensed carrier discovery reference signal transmitted on the unlicensed carrier.

In an embodiment, each measurement configuration further comprises at least one of: a Reference Signal Received Power (RSRP) report threshold indication for indicating an RSRP report threshold, wherein the UE should transmit a measurement report when an RSRP of the unlicensed carrier discovery reference signal measured by the UE on the unlicensed carrier is higher than the RSRP report threshold; and a Reference Signal Received Quality (RSRQ) report threshold indication for indicating an RSRQ report threshold, wherein the UE should transmit a measurement report when an RSRQ of the unlicensed carrier discovery reference signal measured by the UE on the unlicensed carrier is higher than the RSRQ report threshold.

In an embodiment, each measurement report comprises a carrier identifier for identifying the unlicensed carrier associated with the measurement report.

In an embodiment, each measurement report further comprises an RSSI measurement value for indicating a value of an RSSI measured on the unlicensed carrier.

In an embodiment, each measurement report comprises: a carrier identifier for identifying the unlicensed carrier associated with the measurement report; a reference signal configuration indication for indicating a time/frequency position of an unlicensed carrier discovery reference signal transmitted on the unlicensed carrier; and at least one of: an RSRP measurement value for indicating a value of the RSRP of the unlicensed carrier discovery reference signal measured on the unlicensed carrier; and an RSRQ measurement value for indicating a value of the RSRQ of the unlicensed carrier discovery reference signal measured on the unlicensed carrier.

In an embodiment, the step of allocating resources on one or more unlicensed carriers to the UE comprises: determining one or more unlicensed carriers to be allocated to the UE based on the measurement report set; and transmitting to the UE an unlicensed carrier scheduling indication for indicating time/frequency resources on the one or more unlicensed carriers to be allocated to the UE.

In an embodiment, the method further comprises: receiving from the UE a Channel Quality Information (CQI) report indicating an average value of CQI measured by the UE on the one or more unlicensed carriers allocated to the UE.

In an embodiment, the average value of CQI comprises broadband CQI or narrowband CQI.

In an embodiment, the measurement configuration set is carried via Radio Resource Control (RRC) signaling and transmitted over a licensed carrier.

According to a second aspect of the present disclosure, a base station is provided. The base station comprises: a transmission unit configured to transmit to a User Equipment (UE) a measurement configuration set comprising one or more measurement configurations each for configuring measurement for one unlicensed carrier; a reception unit configured to receive from the UE a measurement report set comprising one or more measurement reports each associated with one unlicensed carrier configured by at least one measurement configuration in the measurement configuration set; and a resource allocation unit configured to allocate resources on one or more unlicensed carriers to the UE based on the measurement report set.

The embodiments of the methods according to the above first aspect also apply to the base station.

According to a third aspect of the present disclosure, a method in a User Equipment (UE) is provided. The method comprises: receiving from a base station a measurement configuration set comprising one or more measurement configurations each for configuring measurement for one unlicensed carrier; measuring each unlicensed carrier configured in the measurement configuration set based on the measurement configuration set; transmitting to the base station a measurement report set comprising one or more measurement reports each associated with one unlicensed carrier configured by at least one measurement configuration in the measurement configuration set; and receiving from the base station an unlicensed carrier scheduling indication for indicating resources on one or more unlicensed carriers allocated to the UE.

In an embodiment, each measurement configuration comprises a carrier identifier for identifying the configured unlicensed carrier.

In an embodiment, each measurement configuration further comprises a Received Signal Strength Indicator (RSSI) report threshold indication for indicating an RSSI report threshold. The UE should transmit a measurement report when an RSSI measured by the UE on the unlicensed carrier is lower than the RSSI report threshold.

In an embodiment, each measurement configuration further comprises a reference signal configuration indication for indicating a time/frequency position of an unlicensed carrier discovery reference signal transmitted on the unlicensed carrier.

In an embodiment, each measurement configuration further comprises at least one of: a Reference Signal Received Power (RSRP) report threshold indication for indicating an RSRP report threshold, wherein the UE should transmit a measurement report when an RSRP of the unlicensed carrier discovery reference signal measured by the UE on the unlicensed carrier is higher than the RSRP report threshold; and a Reference Signal Received Quality (RSRQ) report threshold indication for indicating an RSRQ report threshold, wherein the UE should transmit a measurement report when an RSRQ of the unlicensed carrier discovery reference signal measured by the UE on the unlicensed carrier is higher than the RSRQ report threshold.

In an embodiment, each measurement report comprises a carrier identifier for identifying the unlicensed carrier associated with the measurement report.

In an embodiment, each measurement report further comprises an RSSI measurement value for indicating a value of an RSSI measured on the unlicensed carrier.

In an embodiment, each measurement report comprises: a carrier identifier for identifying the unlicensed carrier associated with the measurement report; a reference signal configuration indication for indicating a time/frequency position of an unlicensed carrier discovery reference signal transmitted on the unlicensed carrier; and at least one of: an RSRP measurement value for indicating a value of the RSRP of the unlicensed carrier discovery reference signal measured on the unlicensed carrier; and an RSRQ measurement value for indicating a value of the RSRQ of the unlicensed carrier discovery reference signal measured on the unlicensed carrier.

In an embodiment, the method further comprises: measuring Channel Quality Information (CQI) on each of the one or more unlicensed carriers allocated to the UE and calculating an average value of the measured CQI; and transmitting to the base station a CQI report indicating the average value of CQI.

In an embodiment, the average value of CQI comprises broadband CQI or narrowband CQI.

In an embodiment, the measurement configuration set is carried via Radio Resource Control (RRC) signaling and received over a licensed carrier.

According to a fourth aspect of the present disclosure, a User Equipment (UE) is provided. The UE comprises: a reception unit configured to receive from a base station a measurement configuration set comprising one or more measurement configurations each for configuring measurement for one unlicensed carrier; a measurement unit configured to measure each unlicensed carrier configured in the measurement configuration set based on the measurement configuration set; and a transmission unit configured to transmit to the base station a measurement report set comprising one or more measurement reports each associated with one unlicensed carrier configured by at least one measurement configuration in the measurement configuration set. The reception unit is further configured to receive from the base station an unlicensed carrier scheduling indication for indicating resources on one or more unlicensed carriers allocated to the UE.

The embodiments of the methods according to the above third aspect also apply to the UE.

With the embodiments of the present disclosure, a base station transmits a measurement configuration set to a UE for configuring measurement for an unlicensed carrier, receives a measurement report for the unlicensed carrier from the UE, and then allocates resources on the unlicensed carrier to the UE based on the measurement report. In this way, the present disclosure provides a solution for measurement and/or resource allocation for the unlicensed carrier.

### BRIEF DESCRIPTION OF THE DRAWINGS

The above and other objects, features and advantages will be more apparent from the following description of embodiments with reference to the figures, in which:

FIG. 1 is a block diagram of a base station according to an embodiment of the present disclosure;

FIG. 2 is a flowchart illustrating a method in a base station according to an embodiment of the present disclosure;

FIG. 3 is a block diagram of a UE according to an embodiment of the present disclosure; and

FIG. 4 is a flowchart illustrating a method in a UE according to an embodiment of the present disclosure.

### DETAILED DESCRIPTION

In the following, preferred embodiments of the present disclosure will be described in detail with reference to the drawings. It should be noted that the following embodiments are illustrative only, rather than limiting the scope of the present disclosure. In the following description, details of well known techniques which are not directly relevant to the present invention will be omitted so as not to obscure the concept of the invention.

In the following, a number of embodiments of the present invention will be detailed in an exemplary application environment of LTE mobile communication system and its subsequent evolutions. Herein, it is to be noted that the present invention is not limited to the application exemplified in the embodiments. Rather, it is applicable to other communication systems, such as the future 5G cellular communication system.

FIG. 1 is a block diagram of a base station 100 according to an embodiment of the present disclosure. As shown in FIG. 1, the base station 100 includes a transmission unit 110, a reception unit 120 and a resource allocation unit 130. It can be appreciated by those skilled in the art that the base station 100 further includes other functional units necessary for its functionality, e.g., various processors, memories and the like.

The transmission unit 110 is configured to transmit to a User Equipment (UE) a measurement configuration set including one or more measurement configurations each for configuring measurement for one unlicensed carrier.

In an embodiment, each measurement configuration comprises a carrier identifier for identifying the configured unlicensed carrier.

For example, the carrier identifier can indicate the central frequency of the configured unlicensed carrier. For example, the carrier identifier can be a band indicator corresponding to dl-CarrierFreq or ul-CarrierFreq in TS 36.331. The frequency point information corresponding to the band indicator can be obtained from the E-UTRA operation band in Table 5.7.3-1 of TS 36.101. It is to be noted here that e.g., Table 5.7.3-1 is a table showing new available bands on 5 GHz predefined for LTE-Unlicensed (LTE-U), as shown in Table 1 below.

TABLE 1

| E-UTRA Unlicensed Operation Band | Range (MHz) |
|---|---|
| 1 | 5170-5190 |
| 2 | 5190-5210 |
| 3 | 5210-5230 |
| 4 | 5230-5250 |
| 5 | 5250-5270 |
| 6 | 5270-5290 |
| 7 | 5290-5310 |
| 8 | 5310-5330 |
| 9 | 5490-5510 |
| 10 | 5510-5530 |
| 11 | 5530-5550 |
| 12 | 5550-5570 |
| 13 | 5570-5590 |
| 14 | 5590-5610 |
| 15 | 5610-5630 |
| 16 | 5630-5650 |
| 17 | 5650-5670 |
| 18 | 5670-5690 |
| 19 | 5690-5710 |
| 20 | 5710-5730 |
| 21 | 5735-5755 |
| 22 | 5755-5775 |
| 23 | 5775-5795 |
| 24 | 5795-5815 |
| 25 | 5815-5835 |

Alternatively, the carrier identifier can indicate a frequency range of the unlicensed carrier, e.g., 5170 MHz-5190 MHz. Alternatively, the carrier identifier can indicate a start frequency point of the band of the unlicensed carrier, e.g., 5170 MHz. Alternatively, the carrier identifier can indicate a bandwidth of the unlicensed carrier, e.g., the identifier can be the dl-Bandwidth indication in MasterinformationBlock in TS 36.331. Alternatively, the carrier identifier can be the E-UTRA unlicensed operation band index (1˜25) as shown in Table 1. Alternatively, the index may not be explicitly indicated, but can instead be derived by the UE from the position of the measurement configuration in the entire measurement configuration set.

In an embodiment, each measurement configuration further includes a physical cell identification for indicating a physical cell identification reserved for the corresponding unlicensed carrier. As an example, the physical cell identification can be physCellId in TS 36.331.

In an embodiment, each measurement configuration further includes a Received Signal Strength Indicator (RSSI) report threshold indication for indicating an RSSI report threshold. The UE should transmit a measurement report when an RSSI measured by the UE on the unlicensed carrier is lower than the RSSI report threshold. As an example, the indication can be an integer X, indicating a corresponding RSSI report threshold of X dBm.

In an embodiment, each measurement configuration further includes a reference signal configuration indication for indicating a time/frequency position of an unlicensed carrier discovery reference signal (U-DRS) transmitted on the unlicensed carrier. As an example, the reference signal configuration indication can utilize the configuration schemes currently used for the discovery reference signal in LTE, but with a sparser period. For example, a U-DRS can be transmitted in one subframe every period of 20 ms/40 ms/50 ms/100 ms/200 ms.

Optionally, each measurement configuration further includes a reference signal presence indication for indicating whether a U-DRS is transmitted on the corresponding unlicensed carrier. As an example, the indication can be a Boolean value, e.g., a value of “0” indicates no U-DRS being transmitted and a value of “1” indicates a U-DRS being transmitted.

When a U-DRS is transmitted on the unlicensed carrier, each measurement report includes at least one of: a Reference Signal Received Power (RSRP) report threshold indication for indicating an RSRP report threshold (the UE should transmit a measurement report when an RSRP of the unlicensed carrier discovery reference signal measured by the UE on the unlicensed carrier is higher than the RSRP report threshold) and a Reference Signal Received Quality (RSRQ) report threshold indication for indicating an RSRQ report threshold (the UE should transmit a measurement report when an RSRQ of the unlicensed carrier discovery reference signal measured by the UE on the unlicensed carrier is higher than the RSRQ report threshold). As an example, the RSRP report threshold can be an integer Y, indicating a corresponding RSRP report threshold of Y dBm. The RSRQ report threshold can be an integer Z, indicating a corresponding RSRQ report threshold of Z dBm.

It is to be noted here that the RSSI report threshold indication, the RSRP report threshold indication and the RSRQ report threshold indication are all optional. Each of the RSSI report threshold, the RSRP report threshold and the RSRQ report threshold can be predefined or fixed.

In an embodiment, the measurement configuration set is carried via Radio Resource Control (RRC) signaling and transmitted over a licensed carrier.

The reception unit 120 is configured to receive from the UE a measurement report set including one or more measurement reports each associated with one unlicensed carrier configured by at least one measurement configuration in the measurement configuration set.

In an embodiment, each measurement report includes a carrier identifier for identifying the unlicensed carrier associated with the measurement report.

In an embodiment, each measurement report further includes an RSSI measurement value for indicating a value of an RSSI measured on the unlicensed carrier.

Alternatively, each measurement report includes a carrier identifier for identifying the unlicensed carrier associated with the measurement report; a reference signal configuration indication for indicating a time/frequency position of an unlicensed carrier discovery reference signal transmitted on the unlicensed carrier; and at least one of: an RSRP measurement value for indicating a value of the RSRP of the unlicensed carrier discovery reference signal measured on the unlicensed carrier; and an RSRQ measurement value for indicating a value of the RSRQ of the unlicensed carrier discovery reference signal measured on the unlicensed carrier.

It is to be noted here that, in the measurement report, the RSSI measurement value, the RSRP measurement value and the RSRQ measurement value are all optional. For example, when no U-DRS is configured, upon receiving a measurement report including a carrier identifier only, the base station interprets it as the RSSI measured by the UE on the unlicensed carrier being lower than the RSSI report threshold. For example, when the U-DRS is configured and the RSRP (or RSRQ) report threshold is transmitted or preconfigured, upon receiving a measurement report including a carrier identifier only, the base station interprets it as the RSRP (or RSRQ) of the U-DRS measured by the UE on the unlicensed carrier being higher than the RSRP (or RSRQ) report threshold.

The resource allocation unit 130 is configured to allocate resources on one or more unlicensed carriers to the UE based on the measurement report set.

In an embodiment, the resource allocation unit 130 is configured to determine one or more unlicensed carriers to be allocated to the UE based on the measurement report set. The transmission unit 110 is further configured to transmit to the UE an unlicensed carrier scheduling indication for indicating time/frequency resources on the one or more unlicensed carriers to be allocated to the UE.

Here, the unlicensed carrier scheduling indication can be transmitted to the UE via UE-specific or cell-specific RRC signaling.

For example, the unlicensed carrier scheduling indication can be carried via a Physical Downlink Control Channel (PDCCH) or Evolved PDCCH (EPDCCH) corresponding to one of Downlink Control Information (DCI) formats 1, 1A, 1B, 10, 2, 2A, 2B and 2C currently defined in LTE. A Carrier Indication Flag (CIF) in the DCI format can be used to indicate an index of the allocated unlicensed carrier in an unlicensed carrier candidate set (which is pre-allocated or transmitted to the UE, indicating a set of unlicensed carrier candidates allocated by the bases station to the UE). In the example shown in FIG. 1, if the unlicensed carrier candidate set includes carrier identifiers (indexes) of four unlicensed carriers, {18, 19, 20, 21}, then:
CIF is “00”, indicating that the resources on the allocated unlicensed carrier are 5670-5690 MHz;
CIF is “01”, indicating that the resources on the allocated unlicensed carrier are 5690-5710 MHz;
CIF is “10”, indicating that the resources on the allocated unlicensed carrier are 5710-5730 MHz;
CIF is “11”, indicating that the resources on the allocated unlicensed carrier are 5730-5750 MHz.

In an embodiment, the reception unit 120 is further configured to receive from the UE a Channel Quality Information (CQI) report indicating an average value of CQI measured by the UE on the one or more unlicensed carriers allocated to the UE. For example, the average value of CQI includes broadband CQI or narrowband CQI. Here, the CQI can be an index of a Modulation and Coding Scheme (MCS) and coding rate corresponding to the RSRP and/or RSRQ.

In an embodiment, when no U-DRS is configured, a preamble needs to be transmitted in a head of a subframe of the allocated unlicensed carrier. The time/frequency position occupied by the preamble is the same that of a conventional PDCCH. The number of OFDM symbols occupied by the preamble can be predefined in the system or indicated via RRC signaling over PCC. The base station does not need to transmit Channel State Information Reference Signal (CSI-RS) in the subframe. In this case, the base station can measure CQI based on the preamble. On the other hand, if a U-DRS is configured, the base station does not need to transmit a preamble in the subframe, but transmit a CSI-RS instead. In this case, the UE can measure CQI based on the CSI-RS.

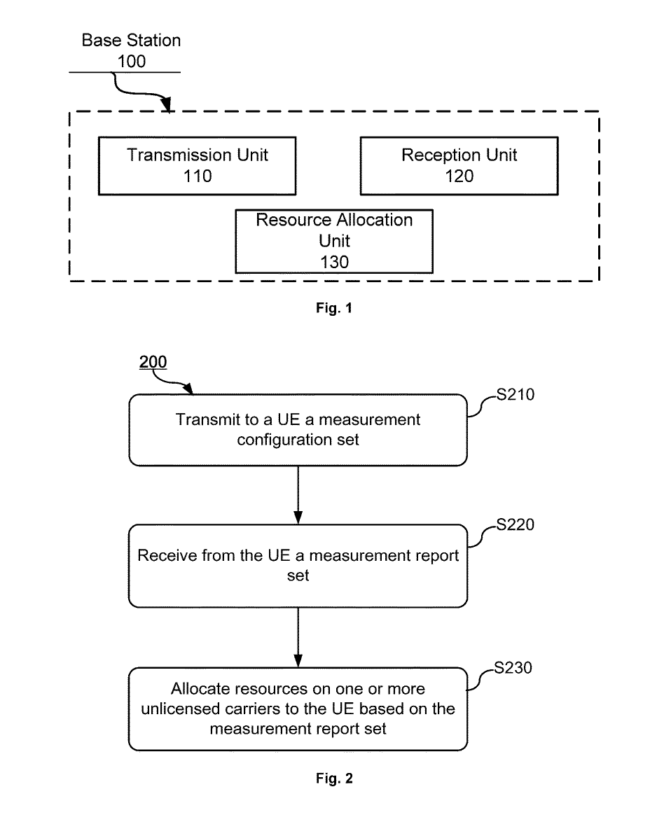

FIG. 2 is a flowchart illustrating a method 200 in a base station according to an embodiment of the present disclosure. It is to be noted that all the features described above in connection with the above embodiment of the base station 100 also apply to the following method embodiment. The method 200 can be performed by the above base station 100 and include the following steps.

At step S210, a measurement configuration set is transmitted to the UE. The measurement configuration set includes one or more measurement configurations each for configuring measurement for one unlicensed carrier.

At step S220, a measurement report set is received from the UE. The measurement report set includes one or more measurement reports each associated with one unlicensed carrier configured by at least one measurement configuration in the measurement configuration set.

At step S230, resources on one or more unlicensed carriers are allocated to the UE based on the measurement report set.

In an embodiment, each measurement configuration includes a carrier identifier for identifying the configured unlicensed carrier.

In an embodiment, each measurement configuration further includes a Received Signal Strength Indicator (RSSI) report threshold indication for indicating an RSSI report threshold. The UE should transmit a measurement report when an RSSI measured by the UE on the unlicensed carrier is lower than the RSSI report threshold.

In an embodiment, each measurement configuration further includes a reference signal configuration indication for indicating a time/frequency position of an unlicensed carrier discovery reference signal transmitted on the unlicensed carrier.

In an embodiment, each measurement configuration further includes at least one of: a Reference Signal Received Power (RSRP) report threshold indication for indicating an RSRP report threshold, wherein the UE should transmit a measurement report when an RSRP of the unlicensed carrier discovery reference signal measured by the UE on the unlicensed carrier is higher than the RSRP report threshold; and a Reference Signal Received Quality (RSRQ) report threshold indication for indicating an RSRQ report threshold, wherein the UE should transmit a measurement report when an RSRQ of the unlicensed carrier discovery reference signal measured by the UE on the unlicensed carrier is higher than the RSRQ report threshold.

In an embodiment, each measurement report includes a carrier identifier for identifying the unlicensed carrier associated with the measurement report.

In an embodiment, each measurement report further includes an RSSI measurement value for indicating a value of an RSSI measured on the unlicensed carrier.

In an embodiment, each measurement report includes: a carrier identifier for identifying the unlicensed carrier associated with the measurement report; a reference signal configuration indication for indicating a time/frequency position of an unlicensed carrier discovery reference signal transmitted on the unlicensed carrier; and at least one of: an RSRP measurement value for indicating a value of the RSRP of the unlicensed carrier discovery reference signal measured on the unlicensed carrier; and an RSRQ measurement value for indicating a value of the RSRQ of the unlicensed carrier discovery reference signal measured on the unlicensed carrier.

In an embodiment, the step of allocating resources on one or more unlicensed carriers to the UE comprises: determining one or more unlicensed carriers to be allocated to the UE based on the measurement report set; and transmitting to the UE an unlicensed carrier scheduling indication for indicating time/frequency resources on the one or more unlicensed carriers to be allocated to the UE.

In an embodiment, the method further includes: receiving from the UE a Channel Quality Information (CQI) report indicating an average value of CQI measured by the UE on the one or more unlicensed carriers allocated to the UE.

In an embodiment, the average value of CQI includes broadband CQI or narrowband CQI.

In an embodiment, the measurement configuration set is carried via Radio Resource Control (RRC) signaling and transmitted over a licensed carrier.

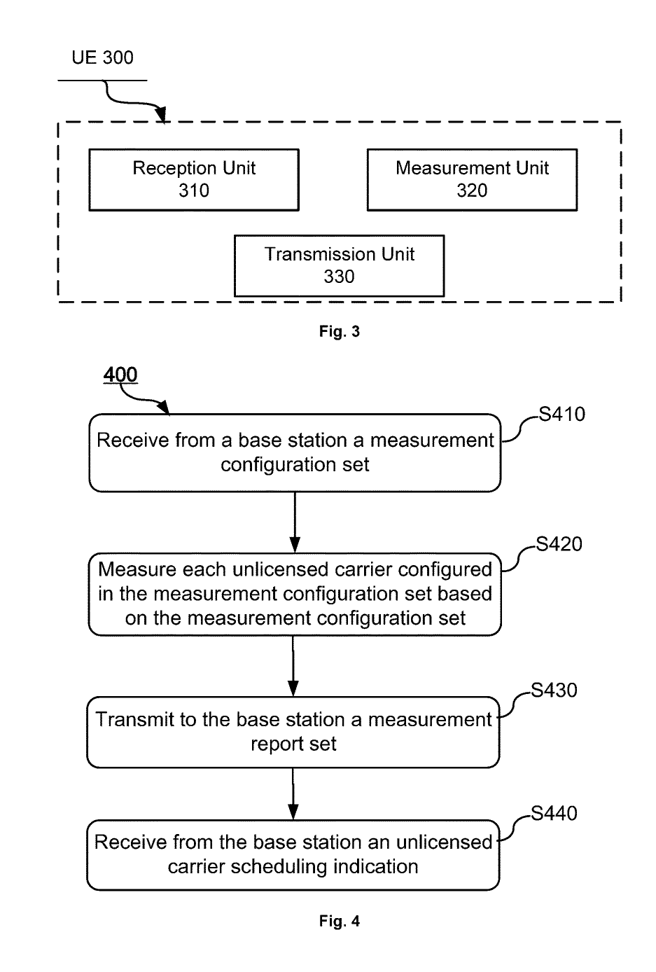

FIG. 3 is a block diagram of a UE 300 according to an embodiment of the present disclosure. As shown in FIG. 3, the UE 300 includes a reception unit 310, a measurement unit 320 and a transmission unit 330. It can be appreciated by those skilled in the art that the UE 300 further includes other functional units necessary for its functionality, e.g., various processors, memories and the like.

The reception unit 310 is configured to receive from a base station a measurement configuration set including one or more measurement configurations each for configuring measurement for one unlicensed carrier.

The measurement unit 320 is configured to measure each unlicensed carrier configured in the measurement configuration set based on the measurement configuration set.

The transmission unit 330 is configured to transmit to the base station a measurement report set including one or more measurement reports each associated with one unlicensed carrier configured by at least one measurement configuration in the measurement configuration set.

The reception unit 310 is further configured to receive from the base station an unlicensed carrier scheduling indication for indicating resources on one or more unlicensed carriers allocated to the UE.

In an embodiment, each measurement configuration comprises a carrier identifier for identifying the configured unlicensed carrier.

In an embodiment, each measurement configuration further comprises a Received Signal Strength Indicator (RSSI) report threshold indication for indicating an RSSI report threshold. The UE should transmit a measurement report when an RSSI measured by the UE on the unlicensed carrier is lower than the RSSI report threshold.

In an embodiment, each measurement configuration further includes a reference signal configuration indication for indicating a time/frequency position of an unlicensed carrier discovery reference signal transmitted on the unlicensed carrier.

In an embodiment, each measurement configuration further includes at least one of: a Reference Signal Received Power (RSRP) report threshold indication for indicating an RSRP report threshold, wherein the UE should transmit a measurement report when an RSRP of the unlicensed carrier discovery reference signal measured by the UE on the unlicensed carrier is higher than the RSRP report threshold; and a Reference Signal Received Quality (RSRQ) report threshold indication for indicating an RSRQ report threshold, wherein the UE should transmit a measurement report when an RSRQ of the unlicensed carrier discovery reference signal measured by the UE on the unlicensed carrier is higher than the RSRQ report threshold.

In an embodiment, each measurement report includes a carrier identifier for identifying the unlicensed carrier associated with the measurement report.

In an embodiment, each measurement report further includes an RSSI measurement value for indicating a value of an RSSI measured on the unlicensed carrier.

In an embodiment, each measurement report includes: a carrier identifier for identifying the unlicensed carrier associated with the measurement report; a reference signal configuration indication for indicating a time/frequency position of an unlicensed carrier discovery reference signal transmitted on the unlicensed carrier; and at least one of: an RSRP measurement value for indicating a value of the RSRP of the unlicensed carrier discovery reference signal measured on the unlicensed carrier; and an RSRQ measurement value for indicating a value of the RSRQ of the unlicensed carrier discovery reference signal measured on the unlicensed carrier.

In an embodiment, the measurement unit 320 is further configured to measure Channel Quality Information (CQI) on each of the one or more unlicensed carriers allocated to the UE and calculating an average value of the measured CQI. The transmission unit 330 is further configured to transmit to the base station a CQI report indicating the average value of CQI.

In an embodiment, the average value of CQI comprises broadband CQI or narrowband CQI.

In an embodiment, the measurement configuration set is carried via Radio Resource Control (RRC) signaling and received over a licensed carrier.

FIG. 4 is a flowchart illustrating a method 400 in a UE according to an embodiment of the present disclosure. It is to be noted that all the features described above in connection with the above embodiment of the UE 300 also apply to the following method embodiment. The method 400 can be performed by the above UE 300 and include the following steps.

At step S410, a measurement configuration set is received from a base station. The measurement configuration set includes one or more measurement configurations each for configuring measurement for one unlicensed carrier.

At step S420, each unlicensed carrier configured in the measurement configuration set is measured based on the measurement configuration set.

At step S430, a measurement report set is transmitted to the base station. The measurement report set includes one or more measurement reports each associated with one unlicensed carrier configured by at least one measurement configuration in the measurement configuration set.

At step S440, an unlicensed carrier scheduling indication is received from the base station, for indicating resources on one or more unlicensed carriers allocated to the UE.

In an embodiment, each measurement configuration comprises a carrier identifier for identifying the configured unlicensed carrier.

In an embodiment, each measurement configuration further comprises a Received Signal Strength Indicator (RSSI) report threshold indication for indicating an RSSI report threshold. The UE should transmit a measurement report when an RSSI measured by the UE on the unlicensed carrier is lower than the RSSI report threshold.

In an embodiment, each measurement configuration further comprises a reference signal configuration indication for indicating a time/frequency position of an unlicensed carrier discovery reference signal transmitted on the unlicensed carrier.

In an embodiment, each measurement configuration further comprises at least one of: a Reference Signal Received Power (RSRP) report threshold indication for indicating an RSRP report threshold, wherein the UE should transmit a measurement report when an RSRP of the unlicensed carrier discovery reference signal measured by the UE on the unlicensed carrier is higher than the RSRP report threshold; and a Reference Signal Received Quality (RSRQ) report threshold indication for indicating an RSRQ report threshold, wherein the UE should transmit a measurement report when an RSRQ of the unlicensed carrier discovery reference signal measured by the UE on the unlicensed carrier is higher than the RSRQ report threshold.

In an embodiment, each measurement report comprises a carrier identifier for identifying the unlicensed carrier associated with the measurement report.

In an embodiment, each measurement report further comprises an RSSI measurement value for indicating a value of an RSSI measured on the unlicensed carrier.

In an embodiment, each measurement report comprises: a carrier identifier for identifying the unlicensed carrier associated with the measurement report; a reference signal configuration indication for indicating a time/frequency position of an unlicensed carrier discovery reference signal transmitted on the unlicensed carrier; and at least one of: an RSRP measurement value for indicating a value of the RSRP of the unlicensed carrier discovery reference signal measured on the unlicensed carrier; and an RSRQ measurement value for indicating a value of the RSRQ of the unlicensed carrier discovery reference signal measured on the unlicensed carrier.

In an embodiment, the method further comprises: measuring Channel Quality Information (CQI) on each of the one or more unlicensed carriers allocated to the UE and calculating an average value of the measured CQI; and transmitting to the base station a CQI report indicating the average value of CQI.

In an embodiment, the average value of CQI comprises broadband CQI or narrowband CQI.

In an embodiment, the measurement configuration set is carried via Radio Resource Control (RRC) signaling and received over a licensed carrier.

Regarding the measurement, report and resource allocation for the unlicensed carrier, all the details described above in connection with the base station 100 also apply to the method 200, the UE 300 and the method 400.

With the embodiments of the present disclosure, a base station transmits a measurement configuration set to a UE for configuring measurement for an unlicensed carrier, receives a measurement report for the unlicensed carrier from the UE, then allocates resources on the unlicensed carrier to the UE based on the measurement report. In this way, the present disclosure provides a solution for measurement and/or resource allocation for the unlicensed carrier.

It can be appreciated that the above embodiments of the present disclosure can be implemented in software, hardware or any combination thereof. For example, the internal components of the base station and the UE in the above embodiments can be implemented using various devices including, but not limited to, analog circuit device, digital circuit device, Digital Signal Processing (DSP) circuit, programmable processor, Application Specific Integrated Circuit (ASIC), Field Programmable Gate Array (FPGA), Programmable Logic Device (CPLD) and the like.

In the present disclosure, the term “base station” refers to a mobile communication data and control exchange center with a large transmit power and a wide coverage area and including functions such as resource allocation/scheduling, data reception/transmission and the like. The term “user equipment” refers to a user mobile terminal, including e.g., a mobile phone, a notebook computer and other terminal devices that can wirelessly communicate with a base station or and micro base station.

Further, the embodiments of the present disclosure can be implemented in computer program products. More specifically, a computer program product can be a product having a computer readable medium with computer program logics coded thereon. When executed on a computing device, the computer program logics provide operations for implementing the above solutions according to the present disclosure. When executed on at least one processor in a computing system, the computer program logics cause the processor to perform the operations (methods) according to the embodiments of the present disclosure.

This arrangement of the present disclosure is typically provided as software, codes and/or other data structures provided or coded on a computer readable medium (such as an optical medium, e.g., CD-ROM, a floppy disk or a hard disk), or firmware or micro codes on other mediums (such as one or more ROMs, RAMs or PROM chips), or downloadable software images or shared databases in one or more modules. The software, firmware or arrangement can be installed in a computing device to cause one or more processors in the computing device to perform the solutions according to the embodiments of the present disclosure.

The present disclosure has been described above with reference to the preferred embodiments thereof. It should be understood that various modifications, alternations and additions can be made by those skilled in the art without departing from the spirits and scope of the present disclosure. Therefore, the scope of the present disclosure is not limited to the above particular embodiments but only defined by the claims as attached and the equivalents thereof.

1. A method in a base station, comprising:
transmitting to a User Equipment (UE) a measurement configuration set comprising one or more measurement configurations each for configuring measurement for one unlicensed carrier;
receiving from the UE a measurement report set comprising one or more measurement reports each associated with one unlicensed carrier configured by at least one measurement configuration in the measurement configuration set; and
allocating resources on one or more unlicensed carriers to the UE based on the measurement report set.

2. The method of claim 1, wherein each measurement configuration comprises a carrier identifier for identifying the configured unlicensed carrier.

3. The method of claim 2, wherein each measurement configuration further comprises a Received Signal Strength Indicator (RSSI) report threshold indication for indicating an RSSI report threshold, wherein the UE should transmit a measurement report when an RSSI measured by the UE on the unlicensed carrier is lower than the RSSI report threshold.

4. (canceled)

5. (canceled)

6. The method of claim 2, wherein each measurement report comprises a carrier identifier for identifying the unlicensed carrier associated with the measurement report.

7. The method of claim 6, wherein each measurement report further comprises an RSSI measurement value for indicating a value of an RSSI measured on the unlicensed carrier.

8. (canceled)

9. (Cancelled)

10. (Cancelled)

11. (Cancelled)

12. (Cancelled)

13. A base station, comprising:
a transmission unit configured to transmit to a User Equipment (UE) a measurement configuration set comprising one or more measurement configurations each for configuring measurement for one unlicensed carrier;
a reception unit configured to receive from the UE a measurement report set comprising one or more measurement reports each associated with one unlicensed carrier configured by at least one measurement configuration in the measurement configuration set; and
a resource allocation unit configured to allocate resources on one or more unlicensed carriers to the UE based on the measurement report set.

14. The base station of claim 13, wherein each measurement configuration comprises a carrier identifier for identifying the configured unlicensed carrier.

15. The base station of claim 14, wherein each measurement configuration further comprises a Received Signal Strength Indicator (RSSI) report threshold indication for indicating an RSSI report threshold, wherein the UE should transmit a measurement report when an RSSI measured by the UE on the unlicensed carrier is lower than the RSSI report threshold.

16. (canceled)

17. (canceled)

18. The base station of claim 14, wherein each measurement report comprises a carrier identifier for identifying the unlicensed carrier associated with the measurement report.

19. The base station of claim 18, wherein each measurement report further comprises an RSSI measurement value for indicating a value of an RSSI measured on the unlicensed carrier.

20. (canceled)

21. (canceled)

22. (canceled)

23. (canceled)

24. (canceled)

25. A method in a User Equipment (UE), comprising:
receiving from a base station a measurement configuration set comprising one or more measurement configurations each for configuring measurement for one unlicensed carrier;
measuring each unlicensed carrier configured in the measurement configuration set based on the measurement configuration set;
transmitting to the base station a measurement report set comprising one or more measurement reports each associated with one unlicensed carrier configured by at least one measurement configuration in the measurement configuration set; and
receiving from the base station an unlicensed carrier scheduling indication for indicating resources on one or more unlicensed carriers allocated to the UE.

26. The method of claim 25, wherein each measurement configuration comprises a carrier identifier for identifying the configured unlicensed carrier.

27. The method of claim 26, wherein each measurement configuration further comprises a Received Signal Strength Indicator (RSSI) report threshold indication for indicating an RSSI report threshold, wherein the UE should transmit a measurement report when an RSSI measured by the UE on the unlicensed carrier is lower than the RSSI report threshold.

28. (canceled)

29. (canceled)

30. The method of claim 26, wherein each measurement report comprises a carrier identifier for identifying the unlicensed carrier associated with the measurement report.

31. The method of claim 30, wherein each measurement report further comprises an RSSI measurement value for indicating a value of an RSSI measured on the unlicensed carrier.

32. (canceled)

33. (canceled)

34. (canceled)

35. (canceled)

36. A User Equipment (UE), comprising:
a reception unit configured to receive from a base station a measurement configuration set comprising one or more measurement configurations each for configuring measurement for one unlicensed carrier;
a measurement unit configured to measure each unlicensed carrier configured in the measurement configuration set based on the measurement configuration set; and
a transmission unit configured to transmit to the base station a measurement report set comprising one or more measurement reports each associated with one unlicensed carrier configured by at least one measurement configuration in the measurement configuration set,
wherein the reception unit is further configured to receive from the base station an unlicensed carrier scheduling indication for indicating resources on one or more unlicensed carriers allocated to the UE.

37. The UE of claim 36, wherein each measurement configuration comprises a carrier identifier for identifying the configured unlicensed carrier.

38. The UE of claim 37, wherein each measurement configuration further comprises a Received Signal Strength Indicator (RSSI) report threshold indication for indicating an RSSI report threshold, wherein the UE should transmit a measurement report when an RSSI measured by the UE on the unlicensed carrier is lower than the RSSI report threshold.

39. (canceled)

40. (canceled)

41. The UE of claim 37, wherein each measurement report comprises a carrier identifier for identifying the unlicensed carrier associated with the measurement report.

42. The UE of claim 41, wherein each measurement report further comprises an RSSI measurement value for indicating a value of an RSSI measured on the unlicensed carrier.

43. (canceled)

44. (canceled)

45. (cancelled)

46. (cancelled)
